(19) United States
(12) Patent Application Publication
(10) Pub. No.: US 2008/0298441 A1
(43) Pub. Date: Dec. 4, 2008

(54) RADIO COMMUNICATIONS APPARATUS

(75) Inventors: Shohei Kikuchi, Fuchu-shi (JP); Yasuhiko Tanabe, Kawasaki-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Kabushiki Kaisha Toshiba

(21) Appl. No.: 12/055,047

(22) Filed: Mar. 25, 2008

(30) Foreign Application Priority Data
May 31, 2007 (JP) 2007-145350

(51) Int. Cl. H04B 1/38

(52) U.S. Cl. 375/219

(57) ABSTRACT

A radio communications apparatus executing transmit beam forming includes a receiver which receives an estimate value of a propagation path response, a computer which calculates a weighting matrix to be used for the transmit beam forming, in accordance with the estimate value, a correcting unit which corrects a component, of components of the weighting matrix, and a beam forming unit which executes beam forming using the weighting matrix corrected by the correcting unit and executes radio transmission.

### CROSS-REFERENCE TO RELATED APPLICATIONS

This application is based upon and claims the benefit of priority from prior Japanese Patent Application No. 2007-145350, filed May 31, 2007, the entire contents of which are incorporated herein by reference.

### BACKGROUND OF THE INVENTION

1. Field of the Invention

The present invention relates to a radio communications apparatus executing beam forming using a plurality of antenna elements.

2. Description of the Related Art

In conventional MIMO (Multi-Input Multi-Output) communications in which a transmitter and a receiver comprise a plurality of antennas to establish communications, if a propagation path response is known to the transmitter side, the transmitter multiplies a transmission signal by a transmission weighting matrix obtained from the propagation path response and transmits the signal, and transmission of the maximum capacity can be executed. This technique is called transmit beam forming.

In addition, as a method of obtaining an optimum transmission weighting matrix in a case the propagation path response is known to the transmitter side and an estimate error of the propagation path response is very small, a method using singular value decomposition is generally known (cf., for example, U.S. Pat. No. 6,058,105 and U.S. Pat. No. 6,144,711). However, if there is a normegligible error between the estimated propagation path response and the actual propagation path response, a problem arises that orthogonality of the transmission weighting matrix obtained by using the singular value decomposition with the actual propagation path response is broken and the transmission performance is thereby deteriorated.

In particular, in the actual environment, occurrence of a delay time (feedback delay) cannot be avoided since a certain period is required until the propagation path response is estimated and beam forming based on the propagation path response is executed. For this reason, an influence to the system transmission performance caused by the variation in the propagation path response is very large.

As a conventional method of relaxing the performance deterioration resulting from the propagation path error as caused by the influence from the feedback delay or the like, a robust transmission weighting matrix permitting an error to some extent is generated (cf., for example, A. Adbel-Samad, T. N. Davidson, and A. B. Gershman, “Robust Transmit Eigen Beamforming Based on Imperfect Channel State Information”, IEEE Transactions on Signal Processing, vol. 54, pp. 1596-1609, May 2006). In this transmission weighting matrix generation method, an upper bound of the error norm between the estimated transmission weighting matrix and the actual transmission weighting matrix is first determined and then the transmission weighting matrix is obtained by using an evaluation function which maximizes the SN ratio under constraint conditions obtained from the determined upper bound of the error norm.

In this method, however, a very precise solution can be theoretically obtained but double calculations of optimization are required and the load on the calculation is prohibitive. In addition, all the columns in the transmission weighting matrix need to be optimized at once. When the size of the propagation path is large, the load of the calculation amount is prohibitive and, therefore, achievement of reduction in the operation amount is a serious problem in equipment.

Furthermore, a problem that the means for determining the upper bound of the error norm in the propagation path is uncertain also arises. In other words, the upper bound of the norm of the error generated between the actual propagation path and the transmission weighting matrix obtained from the estimated propagation path should be determined in accordance with the magnitude of error but there are not means for estimating the upper bound of the error norm from a measurable parameter.

The conventional method has the problems that the transmission performance in transmit beam forming is determined in a case where much time is required until the propagation path is estimated and the transmit beam forming is applied by using the estimated propagation path, and that the operation load is so great to relax the deterioration.

An objective of the present invention is to provide a radio communications apparatus capable of restricting the deterioration in transmission performance of the transmit beam forming without increasing the operation amount even in a case where much time is required until the propagation path is estimated and the estimated propagation path is applied to the transmit beam forming.

### BRIEF SUMMARY OF THE INVENTION

An aspect of the present invention a radio communications apparatus executing transmit beam forming. The apparatus comprises a receiver which receives an estimate value of a propagation path response, a computer which calculates a weighting matrix to be used for the transmit beam forming, in accordance with the estimate value, a correcting unit which corrects components of the weighting matrices, and a beam forming unit which executes beam forming using the weighting matrix corrected by the correcting unit and executes radio transmission.

Therefore, the present invention can provide a radio communications apparatus capable of restricting the deterioration in transmission performance of the transmit beam forming without increasing the operation amount even in a case where much time is required until the propagation path is estimated and the transmit beam forming is applied by using the estimated propagation path.

### BRIEF DESCRIPTION OF THE SEVERAL VIEWS OF THE DRAWING

FIG. 1 is a block diagram showing a configuration of a radio communications apparatus according to an embodiment;

FIG. 2 is a flowchart showing a process of a weighting matrix correction unit;

FIG. 3 is a graph showing a correlation between a propagation path delay time and a norm of weight error; and

FIG. 4 is a graph showing a result of computer simulation.

### DETAILED DESCRIPTION OF THE INVENTION

An embodiment of the present invention will be described below with reference to the accompanying drawings.

First, a narrow-band MIMO communications system using number M of antenna elements for a radio communications apparatus of the transmitting side and number N of antenna elements for a radio communications apparatus of the receiving side will be considered. If an M-th degree transmitted signal vector is represented as s, an N-th degree received signal vector x can be represented below in formula (1) using an N-th×M-th degree propagation path response matrix H:

x=Hs+n (1)

where n represents an N-th degree additional noise vector. A covariance matrix thereof can be obtained below in formula (2) where n^{H} represents a conjugate transpose.

E[nn^{H]=ρ}ₙ²I (2)

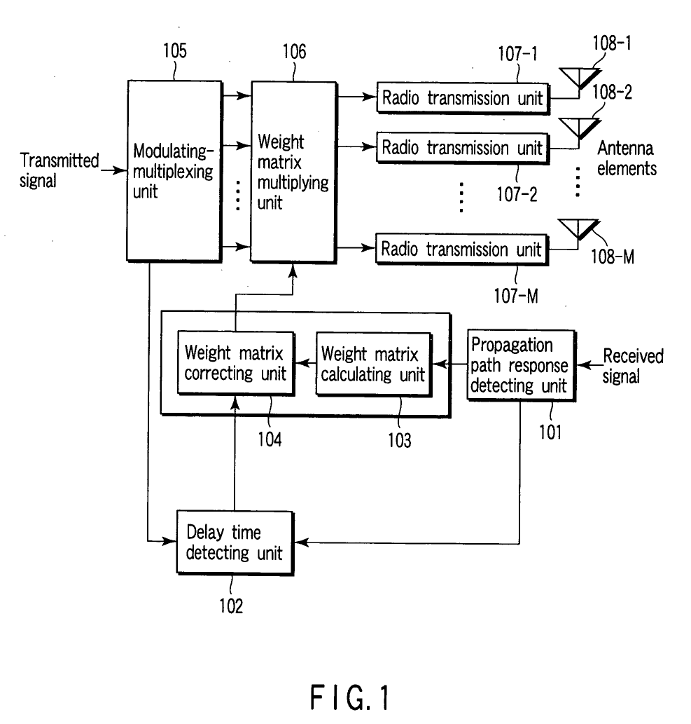

FIG. 1 shows a configuration of a radio communications apparatus according to a first embodiment of the present invention. The radio communications apparatus shown in the figure is the above-described radio communications apparatus of the transmitting side and comprises, as a configuration of the transmitting system, a propagation path response detecting unit 101, a delay time detecting unit 102, a weighting matrix calculating unit 103, a weighting matrix correcting unit 104, a modulating-multiplexing unit 105, a weighting matrix multiplying unit 106, a radio transmission units 107-1 to 107-M, and antennas 108-1 to 108-M.

The radio communications apparatus shown in the figure also comprises a configuration of receiving system (not shown) for receiving the radio signal from the radio communications apparatus of the receiving side. On the other hand, the radio communications apparatus of the receiving side receives the radio signal transmitted via the number M of antenna elements from the radio communications apparatus of the transmitting side, via the number N of antenna elements, estimates the propagation path response, obtains N×M propagation path response estimate matrix Hₑₛₜ indicating the estimation result, and transmits the matrix to the radio communications apparatus of the transmitting side.

The propagation path response detecting unit 101 detects the propagation path response estimate matrix Hₑₛₜ estimated by the radio communications apparatus of the receiving side, from the radio signal received from the radio communications apparatus of the receiving side. When the propagation path response detecting unit 101 detects the propagation path response estimate matrix Hₑₛₜ, the propagation path response detecting unit 101 notifies the delay time detecting unit 102 of the detected timing.

The delay time detecting unit 102 detects the propagation path delay time from the detection timing notified from the propagation path response detecting unit 101 and the timing at which the feedback notified by the modulating-multiplexing unit 105 to be described later is required, and notifies the weighting matrix correcting unit 104 of the propagation path delay time.

The weighting matrix calculating unit 103 obtains estimate value Vₑₛₜ of the singular vector sequence and estimate value Dₑₛₜ of the diagonal matrix formed of the singular value, by processing the propagation path response estimate matrix Hₑₛₜ detected by the propagation path response detecting unit 101 by the singular value decomposition as shown below in formula (3) where Uₑₛₜ and Vₑₛₜ are unitary matrixes having a characteristic that the column vectors are orthogonal to one another as represented below in formula (4) and formula (5), respectively.

Hₑₛₜ=UₑₛₜDₑₛₜVₑₛₜ^{H} (3)

UₑₛₜUₑₛₜ^{H}=Uₑₛₜ^{H}Uₑₛₜ=I (4)

VₑₛₜVₑₛₜ^{H}=Vₑₛₜ^{H}Vₑₛₜ=I (5)

In addition, Dₑₛₜ is a diagonal matrix having the singular values representing the transmission coefficients of the diagonal channels as elements as represented below in formula (6) where m=min(M,N):

Dₑₛₜ=diag[\sqrt{λ₁}, . . . , \sqrt{λₘ}] (6)

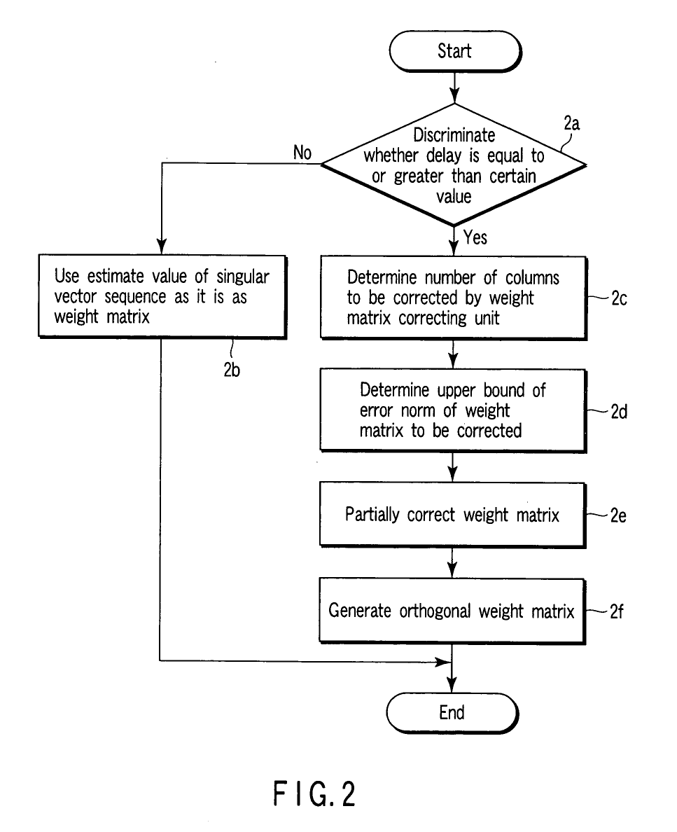

The weighting matrix correcting unit 104 obtains a weighting matrix applied to the transmit beam forming, on the basis of the propagation path delay time notified from the delay time detecting unit 102, the estimate value Vₑₛₜ of the singular vector sequence, and the estimate value Dₑₛₜ of the diagonal matrix. In the following descriptions, the weighting matrix is called transmission weighting matrix, and the operation process of the weighting matrix correcting unit 104 will be described with reference to a flowchart of FIG. 2.

The process shown in FIG. 2 is repeated every time the estimate value Vₑₛₜ of the singular vector sequence and the estimate value Dₑₛₜ of the diagonal matrix are provided from the weighting matrix calculating unit 103. For simple explanations, transmitting two streams from the radio communications apparatus of the transmitting side to the radio communications apparatus of the receiving side (M=2) is assumed, and the weighting matrix correcting unit 104 corrects the only first column of the Mx2-dimensional transmission weighting matrix obtained from the propagation path response estimated on the receiving side, i.e. the only column corresponding to the first stream of the two streams that has great transmission power and also has great receiving level on the receiving side.

First, in step 2a, the weighting matrix correcting unit 104 discriminates whether or not the propagation path delay time detected by the delay time detecting unit 102 is equal to or greater than preset threshold valueτ₀. If the propagation path delay time is equal to or greater than preset threshold valueτ₀, the process proceeds to step 2b. If the propagation path delay time is smaller than preset threshold valueτ₀, the process is ended.

In step 2b, the weighting matrix correcting unit 104 handles the estimate value Vₑₛₜ of the singular vector sequence obtained by the weighting matrix calculating unit 103 as the estimate value of the transmission weighting matrix, supplies each weight based on the estimate value to the weighting matrix multiplying unit 106, and ends the process.

This is because if the propagation path delay time is small, a sufficiently precise transmission weighting matrix can be obtained without correction. In other words, the estimate value Vₑₛₜ of the singular vector sequence obtained by the weighting matrix calculating unit 103 is supplied to the weighting matrix multiplying unit 106 without being corrected by the weighting matrix correcting unit 104. In this embodiment, two left columns in the estimate value Vₑₛₜ of the singular vector sequence are employed as the estimate value of the transmission weighting matrix.

In step 2c, the weighting matrix correcting unit 104 obtains a column having a component greater than the preset threshold value on the basis of the estimate value Dₑₛₜ of the diagonal matrix obtained by the weighting matrix calculating unit 103, and determines the obtained column as the column of the transmission weighting matrix to be corrected. Then, the weighting matrix correcting unit 104 proceeds to step 2d. In this embodiment, the first column of a greater transmission power, of the two-column transmission weighting matrix of the estimate value Dₑₛₜ of the diagonal matrix obtained by weighting matrix calculating unit 103, is generally selected.

In step 2d, the weighting matrix correcting unit 104 determines the upper bound ε of the norm of the error generated between the estimate value Vₑₛₜ of the singular vector sequence obtained by the weighting matrix calculating unit 103 and the transmission weighting matrix obtained from the actual propagation path, on the basis of the magnitude of the propagation path delay time detected by the delay time detecting unit 102. Then, the weighting matrix correcting unit 104 proceeds to step 2e.

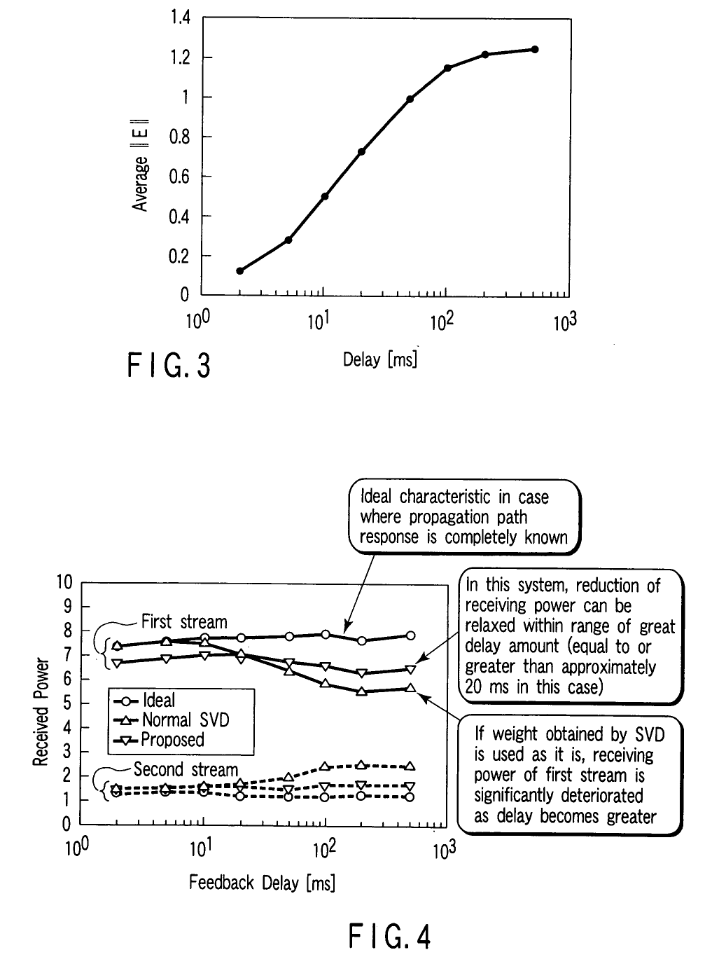

Since the propagation path delay time and the norm of the weight error has a correlation as shown in FIG. 3, the weighting matrix correcting unit 104 preliminarily retains a table based on the correlation and determines the upper bound ε of the norm of the error from the table and the estimate value Vₑₛₜ of the singular vector sequence.

In addition, in this embodiment, the upper bound ε of the norm of the error generated between the first column of the estimate value Vₑₛₜ of the singular vector sequence obtained by the weighting matrix calculating unit 103 and the first column of the transmission weighting matrix obtained from the actual propagation path, is determined on the basis of the magnitude of the propagation path delay time detected by the delay time detecting unit 102.

In step 2e, the weighting matrix correcting unit 104 corrects the estimate value Vₑₛₜ of the singular vector sequence by using the upper bound ε of the norm determined in step 2d. The weighting matrix correcting unit 104 proceeds to step 2f. In this embodiment, the weighting matrix correcting unit 104 corrects the estimate value Vₑₛₜ of the singular vector sequence in the first column alone by using the upper bound ε of the norm. Therefore, the first column w₁ of the transmission weighting matrix considering the influence of the delay time can be obtained by solving the evaluation function which maximizes the receiving power in the first stream in the MIMO transmission. The evaluation function can be defined in formula (7).

$${max}_{{w}_{1}} {w}_{1}^{H} {H}^{H} H {w}_{1} \qquad ( 7 )$$

Formula (7) is optimized under certain constraint conditions. The constraint conditions for optimizing the evaluation function are obtained in formula (8) and formula (9).

∥w₁−v₁ₑₛₜ∥≦ε (8)

∥w₁∥=1 (9)

The finally obtained Mx2-dimensional transmission weighting matrix is expressed below in formula (10).

In other words, w1 and w2 correspond to the transmission weighting matrixes in the first stream and the second stream, respectively. In the formula (8), vest represents the first column of the singular vector sequence.

Actually, propagation path response estimate matrix Hₑₛₜ can be obtained instead of the actual propagation path response H, in the evaluation function of the formula (7). However, if the estimated transmission weighting matrix Hₑₛₜ is used as it is, estimate value w₁ₑₛₜ in the first column of the transmission weighting matrix satisfying the formula (7) matches first column vest of the estimate value Vₑₛₜ of the singular vector sequence.

To avoid this, the propagation path response H in the formula (7) is replaced as represented below in formula (10) where G represents a random matrix of M×N dimensions and a represents a weighting factor selected in a range from 0 to 1.

H=αHₑₛₜ+\sqrt{1−α²}G (10)

Subsequently, the maximization problem in the formula (7) can be equivalently converted into a minimization problem represented below in formula (11).

$${min}_{{w}_{1}} {w}_{1}^{H} {R}^{- 1} {w}_{1} \qquad ( 11 )$$

where R [symbol] H^{H}H

The estimate value in the first column of the transmission weighting matrix can be newly obtained by solving the minimization problem in formula (11) in terms of w1 under the constraint conditions in the formula (8) and formula (9). As a method of calculation, for example, there is a solution of Lagrangian undetermined multipliers can be employed. According to this, function f1 represented in formula (12) is first defined.

f₁(w₁,γ,μ)=w₁^{H}R⁻w₁+γ(∥w₁∥−1)+μ(2−ε²−v₁ₑₛₜ^{H}w₁−w₁ₑₛₜ^{H}v₁ₑₛₜ) (12)

By making a partial differentiation in formula (11) in terms of vector w1 corresponding to the first column of the transmission weighting matrix and solving a partial differentiation represented below in formula (13), undetermined multipliers γ and μ are determined and the vector w1 is obtained.

Estimate value w₁ₑₛₜ in the first column of the transmission weighting matrix obtained in step 2e is not orthogonal to the estimate value v₂ₑₛₜ in the second column of the estimate value Vₑₛₜ of the singular vector sequence.

In step 2f, the weighting matrix correcting unit 104 obtains estimate value w₂ₑₛₜ in the second column of the transmission weighting matrix orthogonal to the estimate value w₁ₑₛₜ in the first column of the transmission weighting matrix obtained in step 2e, on the basis of estimate value v₂ₑₛₜ in the second column of the estimate value Vₑₛₜ of the singular vector sequence obtained in step 2e. As an example of the method of obtaining the estimate value w₂ₑₛₜ, Gram-Schmidt orthogonalization can be employed.

As a result, the estimate value of the transmission weighting matrix to be obtained can be obtained as represented below in formula (14), from the estimate value w₁ₑₛₜ in the first column of the transmission weighting matrix and the estimate value w₂ₑₛₜ in the first column of the transmission weighting matrix orthogonal to the estimate value w₁ₑₛₜ in the first column of the transmission weighting matrix.

Wₑₛₜ=[w₁ₑₛₜ,w₂ₑₛₜ] (14)

The modulating-multiplexing unit 105 modulates a carrier wave by using the transmitted signal, splits the modulation result into number K of streams and outputs the streams to the weighting matrix multiplying unit 106.

Upon requesting feedback of the propagation path estimate value, the modulating-multiplexing unit 105 modulates a carrier wave by using flag data indicating the request for the feedback of the propagation path estimate value, and notifies the delay time detecting unit 102 that the modulating-multiplexing unit 105 has requested the feedback of the propagation path estimate value. The delay time detecting unit 102 thereby starts measuring the time elapsing until the propagation path estimate value is obtained from the receiving side.

The weighting matrix multiplying unit 106 multiplies the number K of streams from the modulating-multiplexing unit 105 by column components corresponding respectively to the estimate values of the transmission weighting matrix obtained by the weighting matrix correcting unit 104. Thus, the number K of streams are mapped to number M of signals and the beam forming is executed.

The radio transmission units 107-1 to 107-M upconvert the number M of signals output from the weighting matrix multiplying unit 106, into radio frequencies, respectively, amplify the power and outputs the upconverted signals to the antennas 108-1 to 108-M, respectively. The radio signals subjected to transmit beam forming are thereby transmitted from the antennas 108-1 to 108-M.

Next, a result of the computer simulation in the radio communications system employing the radio communications apparatus having the above-described configuration will be described. A result of computer simulation shown in FIG. 4 is obtained by executing the transmission of two streams under MIMO communications environment in which the number of antenna elements on each of the transmitting side and the receiving side is 3. In addition, it is assumed in FIG. 4 that a delay time elapses after the radio communications apparatus of the receiving side estimates the propagation path until the radio communications apparatus of the transmitting side applies the transmit beam forming of the two streams.

Then, FIG. 4 shows the receiving power for each of the two streams in case (1) where an ideal transmission weighting matrix is obtained at any time, case (2) where a transmission weighting matrix is obtained by the singular value decomposition, and case (3) where a transmission weighting matrix is obtained by the process in steps 2c to 2f. The receiving power for each of the streams is obtained below in formula (15).

wᵢₑₛₜ^{H}H^{H}Hwᵢₑₛₜ, i=1, 2 (15)

First, in the case (1) where an ideal transmission weighting matrix is obtained at any time, the receiving power is almost constant irrespective of the magnitude in the delay time, as obvious from FIG. 4. Therefore, separate detection of the two streams can easily be executed at any time.

In the (2) where a transmission weighting matrix is obtained by the singular value decomposition (SVD), it can be understood that as the magnitude in the delay time becomes greater, the receiving power for the first stream is lowered and the receiving power for the second stream becomes increased by the interference with the first stream. This indicates that orthogonalization cannot be achieved even if the estimate value of the transmission weighting matrix obtained by the weighting matrix calculating unit 103 is used as it is in the weighting matrix multiplying unit 106, and the separate detection on the receiving side becomes difficult.

In the case (3) where a transmission weighting matrix is obtained by the process in steps 2c to 2f, it can be understood that deterioration of the receiving power for the first stream is restricted in a great range of the delay time as shown in FIG. 4. Therefore, orthogonality between the first stream and the second stream becomes increased and improvement of the effect based on the transmit beam forming can be expected.

With reference to FIG. 4, the result that in the range of the delay time being shorter than about 20 ms, the precision in the case (2) of using the only singular value decomposition is higher than that in the case (3) of the process in steps 2c to 2f. For this reason, by setting the threshold value τ₀ in step 2a below approximately 20 ms, in this embodiment, the transmission weighting matrix is required by the only singular value decomposition (2) in the range of the delay time being below approximately 20 ms while the transmission weighting matrix is required by the process in steps 2c to 2f in the range of the delay time being greater than approximately 20 ms, in the radio communications apparatus of the transmitting side shown in FIG. 1. The optimum transmission weighting matrix is therefore required.

As described above, the fact that the improvement of the transmission performance in the stream having a great receiving power level (i.e. the stream assigned a great singular value) brings about improvement of the transmission performances in the other streams on the receiving side, is focused in the radio communications apparatus having the above-described configuration.

Therefore, the operation amount can be reduced as compared with a case of correcting each of the components in the transmission weighting matrix corresponding to all the streams as executed in the prior art, and the deterioration in the transmission performance of the transmit beam forming can be restricted even if much timer is required to estimate the propagation path and apply the estimated propagation path to the transmit beam forming.

In addition, the upper bound of the error norm between parts of the estimated transmission weighting matrix and parts of the actual transmission weighting matrix is determined in accordance with the magnitude in the delay time elapsing until the propagation path is estimated and the estimated propagation path is applied to the transmit beam forming, and the components in the transmission weighting matrix are corrected on the basis of the determined upper bound. For this reason, the correction can be executed in accordance with the magnitude in the delay time, and the accuracy in restriction of the transmission performance of the transmit beam forming can be enhanced.

Focusing attention on the fact that a sufficient transmission performance as compared with a case of supplying an optimum transmission weighting matrix can be obtained if the delay time is sufficiently small, the above-described correction is not executed but the estimated transmission weighting matrix Hest obtained by singular value decomposition or the like is employed as it is as the transmission weighting matrix if the delay time is smaller than the preset threshold value. For this reason, if the delay time is sufficiently small, waste of the power consumption and operation resources for the operations can be prevented since the operations concerning the above-described correction are not executed.

In addition, focusing attention on the fact that the receiving power for the stream assigned a great singular value becomes significantly reduced as the delay time becomes great, as described above, the correction of the components in the transmission weighting matrix is implemented by optimizing the evaluation function which maximizes the receiving power of the above dominant stream under the constraint conditions supplied by the upper bound of the error norm between the actual value and the estimated transmission weighting matrix Hₑₛₜ obtained by the singular value decomposition or the like.

Furthermore, a part of the transmission weighting matrix which is not subjected to the component correction is subjected to a process orthogonal to the transmission weighting matrix having the components corrected on the basis of the estimated transmission weighting matrix Hₑₛₜ obtained by the singular value decomposition or the like. The orthogonality in the columns of the transmission weighting matrix can be thereby maintained after the correction.

In the above-described embodiment, the only component corresponding to the stream having a great receiving power on the receiving side, of the components of the transmission weighting matrix, is corrected. However, the only component corresponding to the stream having a small receiving power may be corrected. Even in this correction, the effect can be expected to some extent.

Next, a radio communications apparatus according to a second embodiment of the present invention will be described.

The radio communications apparatus according to the second embodiment is the same as the radio communications apparatus according to the first embodiment shown in FIG. 1 in terms of illustrated configuration, and is also the same in terms of the feature that the weighting matrix correcting unit 104 discriminates whether a part of the singular vector sequence should be corrected in accordance with the delay time in step 2a of the process shown in FIG. 2 and, if the correction is needed, calculates the transmission weighting matrix in steps 2e and 2f.

The second embodiment is different from the first embodiment in terms of not executing step 2d, but using a preset predetermined upper bound of error at any time. The upper bound of error used here is, for example, a value of the error norm or the like determined on the basis of an average delay time expected in the radio communications system.

In step 2c, after the weighting matrix correcting unit 104 determines the number of columns to be corrected, the uniquely preset upper bound of error is employed in step 2e at any time. According to this, the operation amount in step 2d can be reduced and, relaxation of the deterioration in transmission performance of the transmit beam forming in the presence of the delay time can be expected.

In a case where the time after the transmitting side requests the feedback of the propagation path estimate value of the receiving side and until the propagation path is received and the transmit beam forming is applied, irregularity in the upper bound of error can be restricted to some extent and the deterioration in transmission performance of the transmit beam forming can be more restricted.

Next, a radio communications apparatus according to a third embodiment of the present invention will be described.

The radio communications apparatus according to the third embodiment is the same as the radio communications apparatus according to the first embodiment shown in FIG. 1 in terms of illustrated configuration, and is also the same in terms of the feature that the weighting matrix correcting unit 104 sets the upper bound of error in accordance with the magnitude in the delay time in step 2d of the process shown in FIG. 2 and calculates the transmission weighting matrix in step 2f.

This embodiment is different from the first embodiment in terms of not executing step 2a or 2b, but correcting the transmission weighting matrix at any time by the process of steps 2c to 2f, irrespective of the magnitude in the delay time. Therefore, if the delay time is very small in step 2d, the weighting matrix correcting unit 104 supplies the upper bound of error in accordance with the delay time.

Since the number of columns to be corrected by the weighting matrix correcting unit 104 is determined in step 2c, prior to step 2d, the columns whose number has been determined in step 2c are corrected in step 2e. Therefore, the deterioration in transmission performance of the transmit beam forming in the presence of the delay time can be relaxed.

In addition, since the delay time detecting unit 102 configured to measure the delay time is not required and the process of steps 2a and 2b are not necessary as compared with the first embodiment, the circuitry can be downsized. Therefore, the effect can be more achieved in the communications environment in which, for example, more than a constant feedback delay cannot be avoided.

Next, a radio communications apparatus according to a fourth embodiment of the present invention will be described.

The radio communications apparatus according to the fourth embodiment is the same as the radio communications apparatus according to the first embodiment shown in FIG. 1 in terms of illustrated configuration, and is also the same in terms of the feature that the weighting matrix correcting unit 104 calculates the transmission weighting matrix in steps 2d and 2e of the process shown in FIG. 2.

The fourth embodiment is different from the first embodiment in terms of omitting both steps 2a and 2b, and not executing step 2d, but using a preset predetermined upper bound of error at any time irrespective of the magnitude in the delay time, similarly to the second embodiment. The upper bound of error used here is, for example, a value of the error norm or the like determined on the basis of an average delay time expected in the radio communications system.

In step 2c, after the weighting matrix correcting unit 104 determines the number of columns to be corrected, the uniquely preset upper bound of error is employed in step 2e at any time. Relaxation of the deterioration in transmission performance of the transmit beam forming, even in the presence of the delay time, can be thereby expected.

In addition, since the delay time detecting unit 102 configured to measure the delay time is not required and the process of steps 2a, 2b and 2d are not necessary as compared with the first embodiment, the circuitry can be downsized.

In a case where the upper bound of the actual weight error is greatly different from that of the set weight error, the convergence time for the optimization calculation is increased. In an environment in which irregularity in the statistic properties of the propagation path is small, however, the effect can be more achieved by using a constant value of the weight error as described above.

Next, a radio communications apparatus according to a fifth embodiment of the present invention will be described.

The radio communications apparatus according to the fifth embodiment is substantially the same as the radio communications apparatus according to the first embodiment shown in FIG. 1 in terms of illustrated configuration, and is also the same in terms of the feature that the weighting matrix correcting unit 104 discriminates whether a part of the weighting matrix should be corrected in step 2a of the process shown in FIG. 2 and, if the correction is necessary, sets the upper bound of error in accordance with the magnitude in the delay time in step 2d and calculates the transmission weighting matrix in steps 2e and 2f.

This embodiment is different from the first embodiment in terms of executing QR decomposition and MMSE (Minimum Mean Square Error), instead of executing the singular value decomposition by the weighting matrix calculating unit 103 for the estimate value of the propagation path response, to obtain the weighting matrix.

In particular, by using Q matrix obtained by executing QR decomposition for matrix Hₑₛₜ^{H}Hₑₛₜ using the estimate value Hₑₛₜ of the propagation path response, as the weighting matrix obtained by the weighting matrix calculating unit 103, the weighting matrix is obtained at a less calculation amount than the singular value decomposition. In this case, the weighting matrix correcting unit 104 discriminates whether a part of the weighting matrix should be corrected in step 2a, determines the column of the weighting matrix to be corrected with the estimate value of the receiving power instead of the singular value in step 2c if the correction needs to be executed, sets the upper bound of error in accordance with the magnitude in the delay time in step 2d, and executes the correction for the column determined in step 2c, in step 2e.

Relaxation of the deterioration in transmission performance of the transmit beam forming, in the presence of the delay time, can be thereby expected. In addition, the operation amount in the weighting matrix calculating unit 103 can be reduced and the circuitry can be more downsized as compared with the first embodiment.

Next, a radio communications apparatus according to a sixth embodiment of the present invention will be described.

The radio communications apparatus according to the sixth embodiment is the same as the radio communications apparatus according to the first embodiment shown in FIG. 1 in terms of illustrated configuration, and is also the same in terms of the feature that the weighting matrix correcting unit 104 discriminates whether a part of the weighting matrix should be corrected in step 2a of the process shown in FIG. 2 and, if the correction is necessary, sets the upper bound of error in accordance with the magnitude in the delay time in step 2d and calculates the transmission weighting matrix in steps 2e and 2f.

This embodiment is different from the first embodiment in terms of applying the present invention to a multi-carrier transmission system such as OFDM (Orthogonal Frequency Division Multiplexing) or the like. By executing the same process as the present invention for each of the subcarriers, the present invention can be applied to the multi-carrier transmission system.

However, even if the present invention is applied to the multi-carrier transmission system, the deterioration in transmission performance of the transmit beam forming due to the delay time can be relaxed. In addition, when the same process is executed according to the number of sub-carriers, reduction of the operation amount and downsizing of the circuitry are more important, and executing the correction of a part of the weighting matrix, similarly to the present invention, has a great effect of reducing the operation amount.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio communications apparatus executing transmit beam forming, comprising:
a receiver which receives an estimate value of a propagation path response;
a computer which calculates a weighting matrix to be used for the transmit beam forming, in accordance with the estimate value;
a correcting unit which corrects a component of components of the weighting matrix; and
a beam forming unit which executes beam forming using the weighting matrix corrected by the correcting unit and executes radio transmission.

2. The apparatus according to claim 1, further comprising:
a request transmitter which transmits a signal to request the estimate value; and
a measuring unit which measures a time elapsing after transmitting the signal to request the estimate value until receiving the estimate value,
wherein the correcting unit outputs the weighting matrix as it is without correcting the component if the time measured by the measuring unit is shorter than a preset time, and corrects the component and outputs the corrected weighting matrix if the time measured by the measuring unit is equal to or longer than the preset time.

3. The apparatus according to claim 1, wherein the correcting unit corrects a component of the components, which corresponds to a signal subjected to radio transmission at a great transmission power.

4. The apparatus according to claim 1, wherein the computer executes singular value decomposition using the estimate value of the propagation path response to obtain the weighting matrix.

5. The apparatus according to claim 4, wherein the correcting unit corrects a component of the components, which corresponds to a great singular value, in accordance with a result of the singular value decomposition executed by the computer.

6. The apparatus according to claim 1, wherein the correcting unit corrects the component within a range of a preset error.

7. The apparatus according to claim 1, wherein the correcting unit corrects the component to a value obtained by solving an evaluation function using a receiving power such that the receiving power becomes maximum.

8. The apparatus according to claim 1, further comprising a measuring unit which measures a time elapsing after transmitting the signal to request the estimate value until receiving the estimate value,
wherein the correcting unit corrects the component within a range of an error corresponding to the time measured by the measuring unit.

9. The apparatus according to claim 8, wherein the correcting unit outputs the weighting matrix as it is without correcting the component if the time measured by the measuring unit is shorter than a preset time, and corrects the component within the range of the error corresponding to the time measured by the measuring unit and outputs the corrected weighting matrix if the time measured by the measuring unit is equal to or longer than the preset time.

10. The apparatus according to claim 1, further comprising a modifying unit which modifies the components of the weighting matrix not corrected, to be orthogonal to the corrected component,
wherein the beam forming unit executes the beam forming using the weighting matrix corrected by the correcting unit.

11. A radio communications method, comprising:
receiving an estimate value of a propagation path response;
calculating a weighting matrix to be used for the transmit beam forming, in accordance with the estimate value;
correcting a component of components of the weighting matrix; and
executing beam forming using the weighting matrix corrected by the correcting unit and executes radio transmission.

12. The method according to claim 11, further comprising:
transmitting a signal to request the estimate value; and
measuring a time elapsing after transmitting the signal to request the estimate value until receiving the estimate value,
wherein the correcting step outputs the weighting matrix as it is without correcting the component if the time measured in the measuring step is shorter than a preset time, and corrects the component and outputs the corrected weighting matrix if the time measured in the measuring step is equal to or longer than the preset time.

13. The method according to claim 11, wherein the correcting step corrects a component of the components, which corresponds to a signal subjected to radio transmission at a great transmission power.

14. The method according to claim 11, wherein singular value decomposition is executed by using the estimate value of the propagation path response to obtain the weighting matrix.

15. The method according to claim 14, wherein the correcting step corrects a component of the components, which corresponds to a great singular value, in accordance with a result of the singular value decomposition.

16. The method according to claim 11, wherein the correcting step corrects the component within a range of a preset error.

17. The method according to claim 11, wherein the correcting step corrects the component to a value obtained by solving an evaluation function using a receiving power such that the receiving power becomes maximum.

18. The method according to claim 11, further comprising measuring a time elapsing after transmitting the signal to request the estimate value until receiving the estimate value,
wherein the correcting step corrects the component within a range of an error corresponding to the time measured in the measuring step.

19. The method according to claim 18, wherein the correcting step outputs the weighting matrix as it is without correcting the component if the time measured in the measuring step is shorter than a preset time, and corrects the component within the range of the error corresponding to the time measured in the measuring step and outputs the corrected weighting matrix if the time measured in the measuring step is equal to or longer than the preset time.

20. The method according to claim 11, further comprising modifying the components of the weighting matrix not corrected, to be orthogonal to the corrected component,
wherein the beam forming step executes the beam forming using the weighting matrix corrected in the correcting step.
